(19) United States
(12) Patent Application Publication
(10) Pub. No.: US 2026/0222869 A1
(43) Pub. Date: Jul. 30, 2026

(54) MEASUREMENT DATA FOR WIRELESS NETWORK BEAM-BASED SENSING

(71) Applicant: SHARP KABUSHIKI KAISHA, Sakai City, Osaka (JP)

(72) Inventor: Kenneth James Park, Vancouver, WA (US)

(21) Appl. No.: 19/145,418

(22) PCT Filed: Dec. 1, 2023
(86) PCT No.: PCT/JP2023/043165

§ 371 Date: Jul. 2, 2025

Related U.S. Application Data
(60) Provisional application No. 63/478,634, filed on Jan. 5, 2023.

(51) Int. Cl. H04W 24/10; G01S 13/02; H04W 72/044; H04W 72/23

(52) U.S. Cl. CPC H04W 24/10; G01S 13/02; H04W 72/046; H04W 72/23

(57) ABSTRACT

A method performed by a receiving device of a New Radio (NR) system configured to detect objects is provided. The method includes receiving, from a transmitting device via a line-of-sight (LOS) path between the transmitting device and the receiving device, a measurement resource configuration indicating time and frequency resources for a sensing signal; receiving, from the transmitting device via another path different from the LOS path, a reflection of the sensing signal via the time and frequency resources; and transmitting, to the transmitting device via the LOS path, a measurement report comprising measurement data, the measurement data including an indication of a direction from which the reflection of the sensing signal was received at the receiving device. A corresponding method for the transmitting device is also provided.

### TECHNICAL FIELD

The present disclosure generally relates to wireless communications and, more specifically, to measurement data for radio frequency (RF) beam-based sensing in a wireless network (e.g., a fifth generation (5G) (e.g., New Radio (NR)) network).

### BACKGROUND ART

RF fingerprinting (RFF) is a technique that leverages the unique characteristics of a transmitter's electromagnetic (EM) emissions to identify the transmitter. At a physical level, an RF fingerprint of a transmitter may be derived by the intrinsic characteristics of a transmitter's hardware that are unintentionally or intentionally embedded in the transmitted waveform (e.g., EM emissions). As such, EM emissions may be imparted with and carry unique and identifiable characteristics.

EM emissions are understood to interact with objects within the transmitting device's coverage area. The interaction may result in a modification (e.g., reflected, refracted, diffracted) of the original characteristics of the EM emission. Such a modification may be directly related to the physical characteristics of the object reflecting the EM emission; thus, the act of reflection may impart new characteristics onto the EM emission that are unique to the reflecting object.

RAdio Detection And Ranging (RADAR or radar) is a mature and well-understood technology that has been in commercial service since the 1940s. Radar uses EM emissions and their associated reflections to determine the distance (e.g., ranging), angle, and radial velocity of objects relative to the site. A radar system includes a transmitter producing EM emissions in the radio or microwave domain, a transmitting antenna, a receiving antenna (often, but not necessarily, the same antenna as the receiving antenna) and a receiver. Radio waves (pulsed or continuous) from the transmitter reflect off of the objects and return to the receiver, giving information about the locations and speeds of the objects. A processor is used to determine the properties of one or more objects as derived from the originated EM emission and the associated EM emissions reflected by the objects.

In its simplest form, a radar system may be implemented as a device that points its transmitting/receiving antenna at an object, radiates a pulse of EM emission and then receives a reflection of the same pulse. By measuring the differential in time between a transmitted pulse and a received pulse, dividing that time by 2, and multiplying the quotient by the speed of light (C), the system can determine the distance of the object from the system (e.g., distance=½*C*(T2−T1)). By comparing the change in distance between two subsequent distance measurements, the system can determine the radial speed of the object.

In a more complex form, a radar system may employ a rotating antenna that transmits and receives the EM emissions pulse. Because such a system can “know” the angle of the antenna at which it transmitted a pulse, it can determine the bearing to the object that reflected the pulse as well as the distance, as described above. By knowing the change in angle between two timing measurements, the system can determine the true speed of the object.

In a more complex form, a radar system can analyze the change in phase of the reflected pulses that it has transmitted to deduce other qualities of the object that reflected the pulse, such as its elevation relative the horizontal plane of the transmit antenna.

Similarly, an EM emission reflected by an object within a Third-Generation Partnership Project (3GPP) NR transmitting device coverage area may be modified (e.g., reflected, refracted, diffracted) by the physical characteristics of the object; thus, the object may impart new characteristics to the reflected EM emission. A system configured to transmit and receive EM emissions may also be enabled with a process to compare and detect changes in the characteristics of received EM emissions to that of the transmitted EM emissions and detect changes between a first EM emission transmission and reception and a second EM emission transmission and reception. The process may subsequently analyze the detected changes to the first EM emission and changes between the first and second (or multiple subsequent) EM emissions to “perceive” or “sense” information about an object (e.g., its shape, its size, its distance from the transmitter, and its location relative to the transmitter) as a function of the object's reflective characteristics that are imparted onto the received EM emissions.

As described in greater detail below, in employing NR to provide such sensing functionality, further innovations to the NR system, such as communications between transmitting and receiving devices involved in sensing operations, are desirable.

### SUMMARY OF INVENTION

In one example, a transmitting device of a New Radio (NR) system configured to detect objects, the transmitting device includes: one or more non-transitory computer-readable media storing a set of computer-executable instructions; and at least one processor coupled to the one or more non-transitory computer-readable media and configured to execute the set of computer-executable instructions to cause the transmitting device to perform operations comprising: transmitting, to a receiving device via a line-of-sight (LOS) path between the transmitting device and the receiving device, a measurement resource configuration indicating time and frequency resources for a sensing signal; transmitting, to the receiving device via another path different from the LOS path, the sensing signal via the time and frequency resources; and receiving, from the receiving device via the LOS path, a measurement report comprising measurement data, the measurement data comprising an indication of a direction from which a reflection of the sensing signal was received at the receiving device.

In one example, a receiving device of a New Radio (NR) system configured to detect objects, the receiving device includes: one or more non-transitory computer-readable media storing a set of computer-executable instructions; and at least one processor coupled to the one or more non-transitory computer-readable media and configured to execute the set of computer-executable instructions to cause the receiving device to perform operations comprising: receiving, from a transmitting device via a line-of-sight (LOS) path between the transmitting device and the receiving device, a measurement resource configuration indicating time and frequency resources for a sensing signal; receiving, from the transmitting device via another path different from the LOS path, a reflection of the sensing signal via the time and frequency resources; and transmitting, to the transmitting device via the LOS path, a measurement report comprising measurement data, the measurement data comprising an indication of a direction from which the reflection of the sensing signal was received at the receiving device.

### BRIEF DESCRIPTION OF DRAWINGS

Implementations of the present technology will now be described, by way of example only, with reference to the attached figures.

FIGS. 1A and 1B are diagrams illustrating a beam sweeping pattern for a transmitting device (e.g., a base station) and a receiving device (e.g., a terminal device), respectively, according to an example implementation of the present disclosure.

FIG. 2 is a timing diagram illustrating the timing of the beam sweeping patterns of FIGS. 1A and 1B, according to an example implementation of the present disclosure.

FIG. 3A is a diagram illustrating transmission of a line-of-sight (LOS) synchronization signal block (SSB) signal from the transmitting device to the receiving device, according to an example implementation of the present disclosure.

FIG. 3B is a diagram illustrating communications between the transmitting device and the receiving device to configure the receiving device to perform sensing signal measurements and generate a measurement report, according to an example implementation of the present disclosure.

FIG. 4A is a diagram illustrating transmission of a non-LOS (NLOS) sensing signal that is transmitted by the transmitting device and reflected by an object toward the receiving device, according to an example implementation of the present disclosure.

FIG. 4B is a diagram illustrating communications between the transmitting device and the receiving device to trigger the measurement of the sensing signals and the generation and transmission of the measurement report at the receiving device, and to transmit the measurement report from the receiving device to the transmitting device, according to an example implementation of the present disclosure.

FIG. 5 is a flowchart illustrating a method performed by a receiving device for a sensing operation, according to an example implementation of the present disclosure.

FIG. 6 is a flowchart illustrating a method performed by a transmitting device for a sensing operation, according to an example implementation of the present disclosure.

FIG. 7 is a flowchart illustrating a method performed by a transmitting device and a receiving device for a sensing operation, according to an example implementation of the present disclosure.

FIG. 8 is a block diagram illustrating a node for wireless communication, according to an example implementation of the present application.

### DESCRIPTION OF EMBODIMENTS

The 3GPP is a collaboration agreement that aims to define globally applicable technical specifications and technical reports for third and fourth generation wireless communication systems. The 3GPP may also define specifications for next generation mobile networks, systems, and devices.

3GPP Long-Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A), and other standards (e.g., 3GPP Releases 8, 9, 10, 11, 12, 13, 14, 15, and so on) including New Radio (NR), which is also known as 5G. However, the scope of the present disclosure should not be limited in this regard. At least some aspects of the systems and methods disclosed herein may be utilized in other types of wireless communication systems.

A wireless communication device may be an electronic device used to communicate voice and/or data to a base station (BS), which in turn may communicate with a network of devices (e.g., a public switched telephone network (PSTN), the Internet, etc.). In describing systems and methods herein, a wireless communication device may alternatively be referred to as a mobile station, a user equipment (UE), an access terminal, a subscriber station, a mobile terminal, a remote station, a user terminal, a terminal, a subscriber unit, a mobile device, etc. Examples of wireless communication devices may include cellular phones, smart phones, personal digital assistants (PDAs), laptop computers, netbooks, e-readers, wireless modems, etc.

In the 3GPP specifications, a wireless communication device may typically be referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In the 3GPP specifications, a BS is typically referred to as a NodeB, an evolved NodeB (eNB), a home enhanced or evolved NodeB (HeNB), a Next Generation NodeB (gNB), or some other similar terminology. As the scope of the disclosure should not be limited to 3GPP standards, the terms “base station,” “NodeB,” “eNB,” “HeNB,” and “gNB” may be used interchangeably herein to mean the more general term “base station.” Furthermore, the term “base station” or “BS” may be used to denote an access point. An access point may be an electronic device that provides access to a network (e.g., a Local Area Network (LAN), the Internet, etc.) for wireless communication devices. The term “communication device” may be used to denote both a wireless communication device and/or a base station. An eNB and/or gNB may also be more generally referred to as a base station device.

It should be noted that, as used herein, a “cell” may be any communication channel that is specified by standardization or regulatory bodies to be used for International Mobile Telecommunications-Advanced (IMT-Advanced), and all of IMT-Advanced, or a subset thereof, may be adopted by 3GPP as licensed bands (e.g., frequency bands) to be used for communication between an eNB and a UE. It should also be noted that in the E-UTRA and E-UTRAN overall description, as used herein, a “cell” may be defined as a “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB and/or gNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s).

“Activated cells” are those configured cells on which the UE is transmitting and receiving. That is, activated cells are those cells for which the UE monitors the physical downlink control channel (PDCCH) and, in the case of a downlink transmission, those cells for which the UE decodes a physical downlink shared channel (PDSCH). “Deactivated cells” are those configured cells for which the UE is not monitoring the transmission of PDCCH. It should be noted that a “cell” may be described in terms of differing dimensions. For example, a “cell” may have temporal, spatial (e.g., geographical), and frequency characteristics.

The 5G communication systems, dubbed New Radio (NR) technologies by the 3GPP, envision the use of time/frequency/space resources to allow for services, such as Enhanced Mobile Broadband (eMBB) transmission, Ultra-Reliable Low-Latency Communications (URLLC) transmission, and massive Machine Type Communication (mMTC) transmission. Also, in NR, single-beam and/or multi-beam operations are considered for downlink and/or uplink transmissions.

Various examples of the systems and methods disclosed herein are now described with reference to the figures, where like reference numbers may indicate functionally similar elements. The systems and methods as generally described and illustrated in the figures herein could be arranged and designed in a wide variety of different implementations. Therefore, the detailed description of the present disclosure as illustrated in the figures is not intended to limit the scope of the present disclosure but is merely representative of the systems and methods.

A basic discussion of some aspects of NR communication technology is provided below, followed by a more specific discussion relating to embodiments described in the present disclosure.

### NR Frame Structure

The 5G NR Frame structure is described in the NR 3GPP standards (e.g., Technical Specification (TS) 38.211). The 5G NR frame structure includes subframes, slots, and symbol configurations. As described above, the 5G NR Supports two frequency ranges: FR1 (which is under 7.125 gigahertz (GHz)) and FR2 (also known as millimeter wave range, which is between 24.25 GHz to 71.2 GHz). NR uses flexible subcarrier spacing derived from basic 15 kilohertz (kHz) subcarrier spacing that is also used in the LTE. A frame may have a duration of 10 milliseconds (ms) which may include 10 subframes each having 1 ms duration, which is similar to the LTE networks. Each subframe may have 24 slots (u being a member of the set of [0 . . . 4]). Each slot may typically include 14 orthogonal frequency division multiplexing (OFDM) symbols. The number of symbols, however, may depend upon the start and length indicator value (SLIV). The radio frames of 10 ms may be transmitted continuously one after the other as per Time Division Duplex (TDD) or Frequency Division Duplex (FDD) topology. A subframe may be of a fixed duration (e.g., 1 ms) whereas a slot's length may vary based on a subcarrier spacing (SCS) and the number of slots per subframe. A slot is 1 ms for 15 kHz, 500 us for 30 kHz, and so on. The subcarrier spacing of 15 kHz may occupy one slot per subframe, whereas the subcarrier spacing of 30 kHz may occupy two slots per subframe, and so on. Each slot may occupy either 14 OFDM symbols or 12 OFDM symbols, depending on the normal cyclic prefix (CP) or extended CP, respectively.

In 5G, a resource grid (RG) is the grouping of uplink (UL) or downlink (DL) time and frequency resources at the physical layer of a given numerology (described below). The time domain is usually expressed as symbols of a slot, and as slots of a subframe, and the frequency domain is typically expressed as the available resource block (RB) (also described below) within the transmission bandwidth.

In 5G, a resource element (RE) is the smallest physical resource in NR which may include one subcarrier during one OFDM symbol. Also, in 5G, one NR Resource Block (RB) may contain 12 subcarriers in the frequency domain, irrespective of the numerology, and is defined only in the frequency domain (e.g., the bandwidth may not be fixed and may be dependent upon the configured subcarrier spacing). Additionally, in 5G, Physical Resource Blocks (PRBs) are the RBs that are used for actual/physical transmission/reception.

### NR Numerology

Numerology is a term used in the 3GPP specification to describe the different subcarrier spacing types, as there are several different types of subcarrier spacing as summarized in the following Table 1 (which is similar to the Table 4.2-1 in TS 38.211) that defines the supported transmission numerologies.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

It should be noted that for the remainder of this disclosure, the terms numerology and subcarrier spacing (SCS) may be used interchangeably. It should also be noted that the term “SCS configuration factor n” may be used to refer to a subcarrier spacing type, where n may belong to the set [0,1,2,3,4], as noted in the table above and is referred to as u.

### NR System Information

System Information (SI) in NR includes a Master Information Block (MIB) and a number of System Information Blocks (SIBs), which are divided into Minimum SI and Other SI. Minimum SI carries basic information required for initial access and for acquiring any other SI. Minimum SI includes MIB and SIB1. For a UE to be allowed to camp on a cell, it may have acquired the contents of the Minimum SI from that cell. Other SI includes all SIBs not broadcast in the Minimum SI. The UE may not need to receive these SIBs before accessing the cell.

The MIB may provide for a System Frame Number (SFN), critical information for the reception of SIB1 (e.g., SCS, subcarrier offset, Demodulation Reference Signal (DMRS) position, and/or PDCCH configuration), a cell barred flag, and/or an intrafrequency reselection allowed flag. The MIB may be mapped on to a Broadcast Control Channel (BCCH) logical channel and may be carried on a Broadcast Channel (BCH) transport channel. The BCH is then mapped onto a Physical Broadcast Channel (PBCH).

The MIB may be transmitted with a periodicity of 80 ms and may be repeated (according to Synchronization Signal Block (SSB) periodicity) within the 80 ms. MIB contents may be the same over the 80 ms period, and the same MIB may be transmitted over all SSBs within the Synchronization Signal (SS) burst set. The MIB may provide the UE with parameters (e.g., Control Resource Set #0 (CORESET #0) configuration) required to acquire SIB1 (e.g., more specifically, information useful for monitoring of a PDCCH for scheduling a PDSCH that carries SIB1).

SIB1 may provide cell selection information, a Public Land Mobile Network (PLMN) list, cell ID, tracking area code, RAN area code, cell reserved flag, connection establishment failure control information, SI scheduling information, serving cell common uplink and downlink configurations (e.g., configuration information for a Random Access Channel (RACH), paging, etc.), Supplementary UL (SUL) configuration, SSB scheduling information, cell-specific TDD UL/DL configurations, a cell's Internet Protocol (IP) Multimedia Subsystem (IMS) emergency bearer support flag (e.g., for UEs in limited service), emergency call over IMS support flag, a UE's timers and constants, access control information, etc.

The SIB1 may carry the most critical information required for the UE to access the cell (e.g., random access parameters). The SIB1 may include information regarding the availability and scheduling of other SIBs (e.g., mapping of SIBs to SI message, periodicity, SI window size, etc.) SIB1 may also indicate whether one or more SIBs are only provided on-demand, in which case SIB1 may also provide a PRACH configuration needed by the UE to request the required SI. The SIB1 may be transmitted on the Downlink Shared Channel (DL-SCH (e.g., a logical channel-BCCH)) with a periodicity of 160 ms and variable transmission repetition periodicity within 160 ms. The SIB1 may be a cell-specific SIB.

The UE may acquire the SI upon cell selection (e.g., upon power on), cell reselection, return from out of coverage, after reconfiguration with sync completion, after entering the network from another Radio Access Technology (RAT), upon receiving an indication that the SI has changed, upon receiving a PWS (Public Warning System) notification, and/or whenever the UE does not have a valid version of a stored SIB.

### Sensing of Non-3GPP Objects

For Rel-19, the 3GPP Service and System Aspects (SA) Working Group 1 (SA1) is conducting a Study on Integrated Sensing and Communication (FS_Sensing (SP-220717)). The study considers use cases, service requirements, and key performance indicators (KPIs) in support of a new sensing feature using 3GPP NR electromagnetic (EM) emission (RF) to passively detect non-3GPP objects. The sensing feature leverages 3GPP NR RF transmission as an energy source for the illumination of objects that are within the coverage area of a 3GPP NR transmitter. Subsequent an object being illuminated (e.g., by the electromagnetic emissions from 3GPP NR RF transmitter), a 3GPP NR RF receiver may receive some fraction of the transmitted 3GPP NR RF energy reflected (and possibly modified) by the object.

In this manner of transmission, modification by reflection, and reception of RF energy, the 3GPP NR system may obtain information about the state of the environment existing within the RF coverage area of a 3GPP NR transmitter and 3GPP NR receiver. Such information about the state of the environment may be used by a sensing process or service of the 3GPP NR system to deduce the presence of discrete objects in the environment. Such a process may analyze the information for changes in the characteristics of received RF energy of a transmitted sensing signal that may have been imparted onto the signal by the signal's interaction with an object (e.g., reflection of the signal) compared to the characteristics of the signal carried by the original transmission.

Such information regarding the state of RF energy and or the characteristics of a signal carried by the RF energy may be obtained by taking measurements of the RF energy (e.g., by detecting and quantifying the RF) and/or the processing, by a receiver, of any signals carried by the RF energy.

While the objectives of SA1 are to develop 3GPP-compliant specifications that capture the use cases and service requirements of a sensing feature, it does not consider how such a feature may be specified by the other working groups (e.g., the physical aspects, as determined by Radio Access Network Working Group (WG) 1 (known as “RAN1”), and the control signaling aspects, as determined by RAN2). Thus, in the present disclosure, we consider how some of the existing 3GPP physical layer and control layer aspects may be leveraged and or modified to meet the service requirements of the sensing feature being discussed by SA1 for Rel-19.

### Potential 3GPP NR Physical Layer Aspects Leveraged to Facilitate a Sensing Feature

### Beam Management

3GPP NR Rel-16 introduced a technique termed “beamforming” that provides for RF energy that is radiated by an NR Rel-16 transmitter to be focused on a specific point in space (e.g., towards a 3GPP NR receiver), rather than have the energy spread in all directions at nearly equivalent power. In addition to focusing the RF energy (or RF beam) on a point in space, the technique also allows for the movement of the beam's foci in 3 dimensions (X, Y, and Z with respect to the transmission point). Taken together, beamforming and beam movement allows the 3GPP NR system to optimize its distribution of radiated RF energy within its coverage areas to enhance and maintain connectivity between transmitter and receiver as the receiver (or transmitter, or both) moves within the RF coverage area of the transmitter.

Note that beamforming is a digital representation of an analog radar system that uses a rotating antenna to reposition the foci of its radiation pattern.

### Signaling

For the purposes of this disclosure, an RF waveform is a quantum-based voltage synthesis of electromagnetic energy that may be used for the transport of data in a communications system, where a synthesized state of electromagnetic energy represents a data state.

A 3GPP NR transmitter may transmit a specific signal (e.g., in time, frequency, modulation, encoded data) that is imparted upon an RF waveform as data. Such a signal may be generated by a process of the 3GPP NR system and may be used by the system, and in conjunction with other aspects of the system, to establish and maintain a communication channel between a 3GPP NR transmitter and a 3GPP NR receiver.

Such signals may be predefined signals occupying specific resource elements within an uplink and downlink time-frequency grid. Examples of such predefined signals are a demodulation reference signal (DMRS), a phase-tracking reference signal (PTRS), a sounding reference signal (SRS), a channel-state information reference signal (CSI-RS), a position reference signal (PRS), and a cell-specific reference signal (CRS). Each of the reference signals is used by the system to meet the needs of a certain function (e.g., positioning, channel quality, timing). Alternately, such signals may be dynamically generated and occupy resource elements within an uplink and downlink time-frequency grid, as dedicated by a scheduling algorithm. Examples of such dynamic signals may include a physical downlink shared channel (PDSCH) and a physical uplink shared channel (PUSCH). Each of the dynamic signals is used by the system to meet the needs of a certain function (e.g., downlink data transport, uplink data transport, and so on).

### Beam Management Procedures

Beam management procedures are a component of 3GPP NR physical (PHY) and medium access control (MAC) layer procedures. The procedures are used to find and then maintain an optimal beam pair between a transmitter and receiver. Technical Report (TR) 38.802 Section 6.1.6.1 [1] defines beam management as three procedures: P-1, P-2, and P-3, described below.
P-1: This procedure considers UE idle mode initial access as based on beams derived from a synchronization signal block (SSB). During the UE's initial access, beam sweeping takes place at both the transmit and the receiver to select the best transmission (Tx) and reception (Rx) beam pair as based on the reference signal received power (RSRP)/reference signal received quality (RSRQ) (or, collectively, RSRP/Q) of a received beam signal. During initial access, the beams configured at the gNB are generally wide and thus not optimal for defining a beam pair that would be used for the transport of data. Therefore, once a transmitter and receiver are connected (e.g., in Radio Resource Control (RRC) connected mode), additional beam sweeping may be employed to further refine the beam pair using CSI-RS (for downlink) and SRS (for uplink) (instead of the SSB used in idle mode).
P-2: This procedure considers how to refine the beam transmitted by the gNB and by the UE, where the beam sweeping happens at the gNB by keeping the UE beam fixed, and where the beam sweeping happens at the UE by keeping the gNB beam fixed. The procedure is based on non-zero-power (NZP) CSI-RS for downlink gNB Tx beam refinement and SRS for UE uplink transmit beam refinement.

After the initial beam establishment, the goal is to further refine the gNB and UE Tx beam to one that has high directivity and high gain (e.g., properties not provided by the SSB beam). Therefore, a set of CSI-RS resources (for the gNB) and SRS resources (for the UE) are configured and transmitted in different directions by using finer beams within the angular range of the beam from the initial acquisition process. The UE or the gNB then measures all of these beams by capturing the signals with a fixed receive beam. Finally, the best transmit beam is selected based on the RSRP measurements on all transmit beams.
P-3: This procedure considers how to refine the receive beam used by the gNB and by the UE, where the receive beam sweeping happens at the UE given a current transmit beam from the gNB, and where the receive beam sweeping happens at the gNB given a current transmit beam from the UE. This process aims to find the best receive beam, which can be a neighbor beam or a refined beam. For this procedure, a set of reference signal resources (NZP-CSI-RS for downlink and SRS for uplink) are transmitted with the same transmit beam, and the UE or gNB receives the signal using different beams from different directions covering an angular range. Finally, the best receive beam is selected based on the RSRP measurements on all receive beams.

As used herein, the term “Rx beam” does not refer to an actual generated at a receiver, but instead refers to the receiver tuning it reception circuitry toward a particular direction. However, to reflect common usage, both the terms “Tx beam” (or “transmit beam”) and “Rx beam” (or “receive beam”) are employed herein.

### Beamforming

Beamforming improves network performance by utilizing a multiple antenna element configuration to focus energy of the RF signals in a direction which results in a better signal-to-noise ratio (SNR) at the receiver. Additionally, beamforming also limits interference from other directions. Beamforming involves the use of multiple antenna radiating elements transmitting the same signal, possibly at different times, to produce a longer and narrower beam in a particular direction. The higher the number of antenna elements, the narrower the beamwidth.

In RRC idle mode, the DL beamforming of the gNB relies on SSB and RSRP feedback from the UEs. The UEs measure the RSRP on multiple SSB resources where each resource corresponds to one direction and reports, to the gNB, the SSB having the highest RSRP.

In RRC connected mode, the DL beamforming of the gNB relies on the CSI-RS and RSRP feedback from the UEs. The UEs measure the RSRP on multiple CSI-RS resources where each resource corresponds to one direction and reports to the gNB the CRI-RS having the highest RSRP.

Further, in connected mode, the UL beamforming of a UE relies on the SRS and RSRP feedback from the gNB. The gNB measures the RSRP on multiple SRS resources where each resource corresponds to one direction and reports to the UE the SRS having the highest RSRP.

### SSB-Based Beam Sweeping

When a UE initially attempts to synchronize with a network, the UE reads the SSB and extracts the Primary Synchronization Signal (PSS), the Secondary Synchronization Signal (SSS), the Physical Broadcast Channel (PBCH), and the Demodulation Reference Signal (DMRS) therefrom. A single SSB may span four orthogonal frequency division multiplex (OFDM) symbols in time and 240 subcarriers in frequency (e.g., 20 resource blocks). A group of SSBs may form one synchronization signal (SS) burst set. An SS burst set spans 5 ms. Each SSB of an SS burst set is associated with a specific beam, and each specific beam is beamformed in a different direction. The SS burst set may have a periodicity of 20 milliseconds (ms). The higher the frequency used by the NR transmitter, the more SSBs per SS burst. In some implementations, the maximum number of predefined directions (beams and/or SS blocks) in the SS burst set is frequency-dependent, wherein up to 3 gigahertz (GHz) there are four SSBs/SS burst; from 3 GHz to 6 GHZ, there are eight SSBs/SS burst, and from 6 GHz to 52.6 GHz, there are 64 SSBs/SS burst.

Beam sweeping may be used during initial access by the UE to choose the best beam of the SS burst set. During the beam sweeping process, a gNB may transmit the SS burst set such that the beams of the burst set cover all directions, where the SS burst occurs at regular defined intervals (e.g., 20 ms).

As a first step, an SS burst is configured to generate a beam sweep. The next step is to beamform each of the SSBs (e.g., via analog antenna control for each SSB) within the SS burst. Such beamforming may produce a sweep over both azimuth and zenith rotational directions.

The receiver processes the received signal for each of the multiple received beams. The RSRP/Q for each received beam may be measured and thus used to determine the beam with the maximum RSRP/Q.

To uniquely identify the transmitting beam that is associated with a received beam, the receiving UE may decode the SSB of each received beam and recover the unique information associated with that SSB. Each SSB may include a “time index” parameter that renders the SSB unique. By connecting an SSB time index with a specific random-access channel (RACH) resource (slot and/or preamble), the UE will use that time index when accessing the cell. The base station (gNB) may then know which beam the UE prefers. In this way, the best beam-pair between the transmitter and receiver can be identified. This beam may then be used as an initial beam for subsequent DL transmissions to the UE.

Steps used by a beam management process may include (1) Tx Beam Sweep, (2) Rx Beam Sweep, and (3) Beam Measurement/Determination.

To generate a beam sweep at the transmitter, a beamform may be applied to each of the SSBs of the SS burst using analog beamforming. The number of SSBs in the SS burst and the specified sweep range determine both the azimuth and zenith for the different beams.

For receiver-end beam sweeping, the transmitted beamformed SS burst waveform may be received successively over each receive beam. For N transmit beams and M receive beams, each of the N beams may be transmitted M times from the gNB so that each transmit beam is received over the M receive beams.

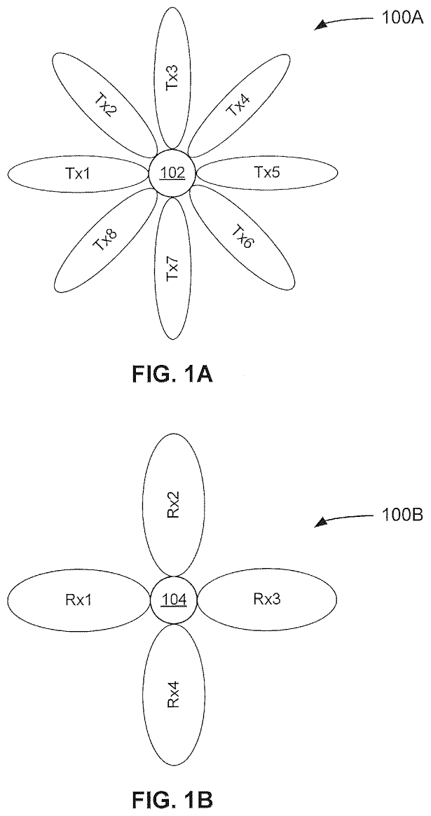

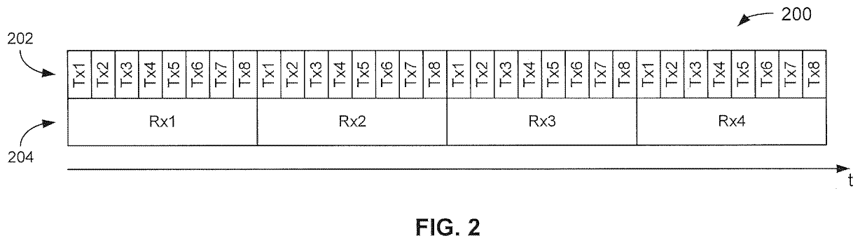

FIGS. 1A and 1B are diagrams illustrating a beam sweeping pattern for a transmitting device 102 (e.g., a base station, such as a gNB) and a receiving device 104 (e.g., a terminal device, such as a UE), respectively, according to an example implementation of the present disclosure. FIG. 2 is a timing diagram 200 illustrating the timing of the beam sweeping patterns of FIGS. 1A and 1B. As shown, a beam sweep 202 for the transmitting device 102 employs a number of Tx beams N=8 (more specifically, Tx1, Tx2, Tx3, Tx4, Tx5, Tx6, Tx7, and Tx8), while a beam sweep 204 for the receiving device 104 employs a number of Rx beams M=4 (more specifically, Rx1, Rx2, Rx3, and Rx4). As indicated above, other numbers of Tx beams and Rx beams may be employed in other examples. In some implementations, each Tx beam at the transmitting device 102 may represent an SSB of an SS burst, and each Rx beam at the receiving device 104 may correspond to an SS burst. As illustrated in FIG. 2, a full sweep of the Tx beams (Tx1-Tx7) at the transmitting device 102 may be performed for each Rx beam at the transmitting device 102.

While the Tx and Rx beams of FIGS. 1A and 1B are represented as two-dimensional beams and associated beam patterns, the Tx and Rx beams are more accurately viewed as three-dimensional beams that may be directed in any direction in three-dimensional space.

In the following discussion, a gNB is employed as an example of the transmitting device 102, and a UE is employed as an example of the receiving device 104. However, other NR devices not mentioned herein may be used as the transmitting device 102 and the receiving device 104 in other implementations of the present disclosure.

### CSI-RS and SRS Based Beam Sweeping

A channel state information reference signal (CSI-RS) is a reference signal (RS) that is used in the downlink (DL) direction in 5G NR for the purpose of channel sounding and employed to measure the characteristics of a radio channel so that correct modulation, code rate, beamforming, etc. may be determined. UEs may use these reference signals to measure the quality of the DL channel and report this information in the UL through channel quality information (CQI) reports. The gNB may send CSI-RSs to report channel status information (CSI), such as CSI reference signal received power (CSI-RSRP), CSI reference signal received quality (CSI-RSRQ), and CSI signal-to-interference-and-noise ratio (CSI-SINR), for mobility procedures. Specific instances of CSI reference signals can be configured for time/frequency tracking and mobility measurements. CSI-RSs may also be used for Radio Resource Management (RRM) measurements for mobility management purposes in connected mode.

It is possible to configure multiple CSI-RS to the same SS burst in such a way that the UE may first obtain synchronization with a given cell using the SS bursts, and then use that synchronization as a reference to search for CSI-RS resources. Therefore, the CSI-RS measurement window configuration should contain at least the periodicity and time/frequency offsets relative to the associated SS burst. There may be two options considered for the time offset of the CSI-RS transmissions. The first option allows the transmission of the first CSI-RS at some periodicity in milliseconds after the end of an SS burst. The second option may include an additional parameter, which may be an offset in time with the offset between the end of the SS burst and the first CSI-RS, which represents the time interval between the end of the SS burst and the first CSI-RS. The CSI-RSs, which may not necessarily be broadcast through all the available frequency resources, may span N=1, 2, or 4 OFDM symbols. For periodic CSI-RS transmissions, the supported periodicities may be T_{CSI-RS}, slot∈{5, 10, 20, 40, 80, 160, 320, 640} slots; thus, the actual periodicity in time may depend on the slot duration.

SRS is a reference signal sent in the UL (from the UE to the gNB) in 3GPP NR to measure channel quality. In particular, SRS receptions at the gNB may provide information about the combined effect of multipath fading and power loss of the transmitted signal from the UE. Based on SRS reception, the gNB may make informed decisions for resource allocation and scheduling, link adaptation (e.g., modulation and coding scheme selection), inter-cell interference management, and beam management. According to 3GPP NR specifications, SRS transmissions can be periodic, aperiodic, or semi-persistent. In the time domain, the range for an SRS transmission in a slot is from the 8th to 13th OFDM symbol. NR leaves the 14th symbol in a slot available for PUCCH. Within such a 6-OFDM symbol region, SRS transmissions may occupy a maximum four OFDM symbols in the time domain. In the frequency domain, the bandwidth for SRS may be adjusted, and interleaving is permitted. Interleaving is defined by a so-called transmission combination, which defines the frequency distance between two subcarriers used by SRS. Based on such a pattern, multiple SRS signals (from different antenna ports or UEs) may be multiplexed in the same OFDM symbol.

### Beam Measurement

After the OFDM demodulation, a UE may measure the beam strength by measuring its received signal power. In RRC idle mode, the beam's RSRP/Q may be derived from the transmission of the synchronization signals (SSB), and in RRC connected mode, the beam's RSRP/Q may be derived from the transmission of the CSI-RS in the downlink and the SRS in the uplink. A UE may periodically search for the beam that has the highest RSRP.

### Beam Count

The number of wide SSB beams and number of narrow traffic beams of a cell with high-band analog beamforming from RRC signaling on the UE side only is dependent upon that the maximum number of beamforms that can be associated with a SSB, which is 12 (e.g., at most 12 SSB beamforms in a SS Burst). For each SSB beamform (e.g., a serving parent SSB beam), there may be a maximum of six CSI-RS narrow beamforms associated therewith (e.g., the six CSI-RS beams may be transmitted in the spatial domain of one SSB beam).

### Beam Reporting

While in idle mode, and after synchronization with the system, a UE may transmit a RACH preamble in one or more intervals with a particular time and frequency offset. After the UE has selected a beam while in idle mode (or when the UE is out-of-sync with the network), the UE may transmit the RACH preamble during an interval corresponding to the SSB for which the best beam was identified. Because the mapping between the received SSB and the transmitted RACH preamble is known by the gNB, the transmission of a RACH preamble by the UE at a specific period may be used by the UE to indicate the best beam received at the UE to the gNB.

### Measurement Reporting

The network may configure a UE to perform certain measurements at a certain time and report the measurements at preconfigured intervals. In connected mode, when the UE is already engaged in active data transfer with the gNB, the UE may report the beam measurement via a measurement report to the gNB.

### Use of Beam Management Functionality for Sensing

In implementations of the present disclosure, to determine the presence and location of an object in the RF coverage area of a 3GPP NR transmitter relative to the transmitter's location, the sensing feature may use beam management functionality to steer a beam towards and/or away from an object of interest.

To control the steering of the beam, an algorithm (referred to herein as a “control loop”) may be used. Such a control loop may direct a transmitting device to shift the focus of its transmitted RF beam in any of the three physical dimensions and in time. To make such a determination as to changing the position of an RF beam's focus, the control loop may consider aspects of a currently transmitted RF beam (e.g., a current position of its focus, its transmission power (e.g., in decibel-milliwatts (dBm)), and so on). The control loop may also take into account aspects of a currently transmitted signal carried by an RF beam (e.g., its location on the time and frequency grid, the periodicity at which the signal occurs in the time and frequency grid, the modulation scheme (e.g., Zadoff-Chu sequence, Gold sequence, or M-sequence) used to encode the signal on the RF beam, and so on).

In some implementations, the control loop may further take into account aspects of a recently received signal (e.g., its location on the time and frequency grid, the periodicity at which the signal occurs in the time and frequency grid, the modulation scheme (e.g., Zadoff-Chu sequence, Gold sequence, or M-sequence) used to encode the signal on an RF beam, the power of the signal at the receive beam, the angle (e.g., azimuth and zenith) of the receive beam relative to the receive antenna of the receiving device, the time at which the beam was received by the receiving device, the location of the receiving device, and/or the orientation of the receiving device (e.g., with respect to North).

A received signal may be considered as one of two types. The first type is a line-of-sight (LOS) signal, and the second is a non-line-of-sight (non-LOS or NLOS) signal. An LOS signal refers to a signal that has traveled directly from the transmitting device to the receiving device and, as such, the signal has not interacted with any reflective objects between the transmitting device and the receiving device. An NLOS signal is any signal that is not a LOS signal.

For purposes of this disclosure, any transmitted signal can have at most one reception by a given receiving device that is of type LOS. All other receptions of that signal by a given receiving device are due to reflections and are considered NLOS receptions.

In addition, for purposes of this disclosure, a transmitted signal is a unique and finite quantity carried by EM emission at the instant in time of transmission. After that instant in time, the transmitted signal may propagate in more than one direction, and thus there may be multiple copies of that signal in free space. As such signals are composed of EM emissions, and EM emissions in free space may be reflected by EM-reflective objects, multiple instances of the signal may be reflected from one or more EM-reflective objects such that the one or more reflections of the signal converge onto a receiving device, where the multiple reflected signals are all separated in time, power, phase, and receive angle.

Generally, as an LOS signal traverses the shortest distance from the transmitting device to the receiving device, the LOS signal takes less time to travel that distance than an NLOS signal due to the extra distance incurred by the sum of the distance from the transmitting device to the reflecting object, and from the reflecting object to the receiving device of the NLOS signal.

Further, because an NLOS signal has taken a different path from the transmitting device to the receiving device than the LOS signal, the angle at which the NLOS arrives at the antenna of the receiving device is different than the angle at which the LOS signal arrives at the same antenna.

Additionally, because an NLOS signal has traveled a longer distance from the transmitting device to the receiving device than the associated LOS signal, the power of the NLOS signal as received at the receiving device is generally less than the power of the LOS signal at the receiving device due to propagation loss incurred by the NLOS signal, as the signal has traveled a longer distance from the transmitting device to the receiving device.

Note that because an NLOS signal has been reflected by some object between the transmitting device and the receiving device, the power of the NLOS signal, as received at the receiving device, is less than the power of the LOS signal, as received by the same receiving device, due to some amount of RF power being absorbed by the reflecting object.

Also, because an NLOS signal has traveled a longer distance from transmitter to receiver than the LOS signal, the phase of the NLOS signal, as received at the receiving device, may be different than the phase of the LOS signal received at the same receiving device, as the phase of a signal at the receiving device is a function of the distance from the transmitting device to the receiving device and the wavelength of the signal.

Therefore, by taking into account various difference characteristics imposed onto an NLOS signal relative to the corresponding LOS signal (e.g., differences in time, angle, power, phase, and/or the like) as the signal travels along an NLOS path from the transmitting device to the receiving device, a sensing system is able to deduce information about the object that reflected the original signal from one or more NLOS signals received at the receiving device that have been imparted with those characteristics.

Thus, a receiving device that is configured to measure reflected (NLOS) signals may include as part of its measurement report (e.g., to the sensing system evaluating the signal for the presence of reflecting objects in the RF field of the transmitting device) information that is additional to a signal measurement report on the power of a received signal. Such additional information regarding NLOS signals received at a receiving device may include one or more of the following:
(1) Identity of a receive beam that received a sensing signal (e.g., a beam index), and the identity of the transmit beam that transmitted the sensing signal received by the receive beam (e.g., a transmitted signal's beam index) as an associated pair.
(2) RSRP/RSRQ/SINR/phase of a receive beam.
(3) Azimuth Angle of Arrival (AOA) of a received signal by the receive beam of a Tx/Rx beam pair.
(4) Zenith Angle of Arrival (AOA) of a received signal by the receive beam of a Tx/Rx beam pair.
(5) Current position (e.g., latitude, longitude, and altitude) of the receiving device.
(6) Orientation of the receiving device antenna with respect to North (or some other horizontal reference direction).
(7) Orientation of the receiving device antenna with respect to the horizon (or some other reference direction orthogonal to the other orientation, such as a vertical reference direction).
(8) Timestamp related to the reception of a transmitted sensing signal by a receive beam of a Tx/Rx beam pair.

The present disclosure, as described in greater detail below, includes the reporting by a receiving device of new such measurement data of a sensing signal as indicated in a measurement report. In some implementations, the measurement report of the measurement data may be enabled on the receiving device by the transmitting device. The transmitting device may be in communication with the receiving device, and the transmitting device may further transmit sensing signals (e.g., NLOS signals that have taken an NLOS transmission path from the transmitting device to the receiving device) for reception by the receiving device.

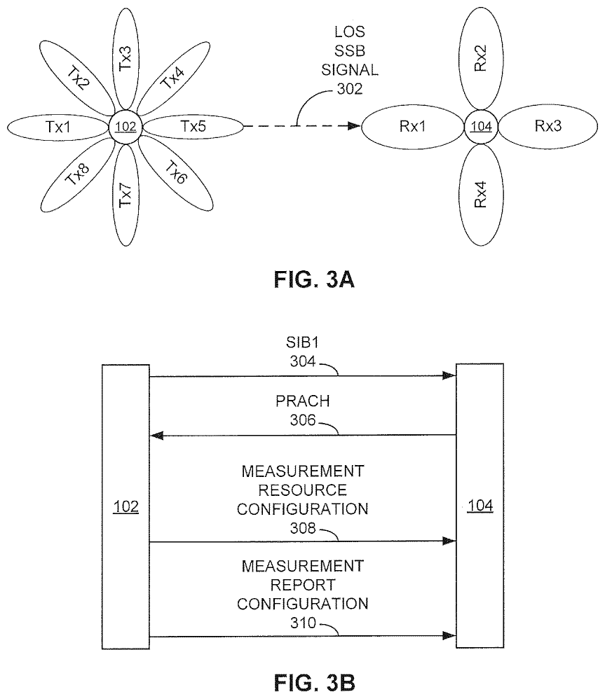

In FIGS. 3A, 3B, 4A, 4B, and 5-7, as well as the accompanying descriptions below, references are made to the transmitting device 102 and the receiving device 104 of FIGS. 1A and 1B. While the following discussion refers to the transmitting device 102 as a device that transmits sensing signals (e.g., a gNB) and the receiving device 104 as a device that receives the sensing signals (e.g., a UE), other types of devices aside from gNBs and UEs may serve as the transmitting device 102 and the receiving device 104 in other implementations. Also, despite the use of the terms “transmitting device” and “receiving device”, the receiving device 104 sometimes transmits signals to the transmitting device 102 to enable various operations, as discussed in greater detail below.

Moreover, with respect to FIGS. 3A, 3B, 4A, 4B, and 5-7, while a particular set of operations is depicted and described, greater or fewer operations than those shown may be performed. Also, while a particular order for the depicted operations is shown, other orders of execution may also be possible.

FIG. 3A is a diagram illustrating transmission of an LOS synchronization SSB signal from the transmitting device 102 to the receiving device 104, according to an example implementation of the present disclosure. FIG. 3B is a diagram illustrating communications between the transmitting device 102 and the receiving device 104 associated with the LOS SSB signal 302 to configure the receiving device 104 to perform sensing signal measurements and generate a measurement report, according to an example implementation of the present disclosure.

As described above, in some implementations, the transmitting device 102 may transmit (e.g., broadcast) a System Information Block 1 (SIB1) 304 that includes SSB scheduling information to facilitate initial access by the receiving device 104 to the transmitting device 102. The SSB scheduling information may include an indication of the time and frequency resources of the SSBs being transmitted via transmit beams Tx1-Tx8 (e.g., ssb-PositionsInBurst in SIB1 304), periodicity of the SSBs (e.g., ssbPeriodicityServingCell in SIB1), and so on. An example of the timing of the SSBs broadcast by the transmitting device 102 is shown in a timing diagram 200 of FIG. 2.

Based on SSB scheduling information of SIB1 304 being received at the receiving device 104, the receiving device 104 may generate a beam sweep operation for receive beams Rx1-Rx4, as shown in the timing diagram of FIG. 2. As indicated in FIG. 3A, during the beam sweep operation, the receiving device 104 may determine that the best beam pair (e.g., in terms of the highest RSRP/Q being measured) for receiving and decoding the SSB (LOS SSB signal 302) from the transmitting device 102 may be receive beam Rx1 and transmit beam Tx5, as identified in the scheduling information of SIB1 304.

As a result of identifying the best beam pair and decoding the SSB associated with the beam pair, the receiving device 104 may transmit a physical random-access channel (PRACH) 306 to the transmitting device 102 using time and frequency resources associated with the SSB 304 received using the timing of the same beam pair (e.g., Rx1 and Tx5) for transmission from the receiving device 104 to the transmitting device 102.

Based on the time and frequency resources on which the transmitting device receives the PRACH 306 from the receiving device 104, the transmitting device 102 may identify the beam pair (e.g., Rx1 and Tx5) by which the receiving device 104 received the LOS SSB signal 302.

Given the identification of the beam pair associated with LOS SSB signal 302, the transmitting device 102 may then configure the receiving device 104 using the same beam pair for sensing operations. More specifically, the transmitting device 102 may transmit one or more measurement resource configurations 308 and one or more measurement report configurations 310 to the receiving device 104 to configure the receiving device 104 for sensing operations prior to triggering the sensing operation.

In some implementations, the measurement resource configuration 308 may identify measurement resources for at least one sensing system reference signal (SS-RS) to be transmitted by the transmitting device 102 and measured by the receiving device 104. In some implementations, the SS-RS may be a reflected version of a CSI-RS transmitted from the transmitting device 102, as received by the receiving device 104. In some implementations, the measurement resource configuration 308 may be an RRC Reconfiguration Message (e.g., RRCReconfiguration (CSI-MeasConfig(CSI-ResourceConfigToAddModList(CSI-ResourceConfig (Config [0 . . . n] for SS-RS))))). Examples of the types of information included in the measurement resource configuration 308 may include, but are not limited to, a configuration identifier (ID), a trigger type (e.g., periodic, aperiodic, or other), a sensing signal (SS-RS) type (e.g., CSI-RS, PRS, or the like), a periodicity of the SS-RS, a received power threshold, and the time and frequency resources of the SS-RS to measure.

In some implementations, the measurement report configuration 310 may identify the types and/or forms of measurement information regarding the received (reflected or NLOS) signals (e.g., the SS-RS signals identified in the measurement resource configuration 308) that is to be reported by the receiving device 104 to the transmitting device 102. For example, the measurement report configuration 310 may be an RRC Reconfiguration Message (e.g., RRCReconfiguration(CSI-MeasConfig(CSI-ReportConfigToAddModList(CSI-ReportConfig(Config [0 . . . n] for SS-RS))))). Examples of the types of information included in the measurement report configuration 310 may include, but are not limited to, a configuration identifier (ID) (e.g., the configuration ID provided to the receiving device in the measurement resource configuration 308), a type of measurement/report (e.g., periodic), a type of event to be reported, a purpose for the report (e.g., ReportCGI (Report Cell Global ID), ReportSFTD-NR (Report System Frame Number (SFN) and Frame Timing Difference), etc.), and so on.

After the transmitting device 102 configures the receiving device 104 for the desired measurements, as described above, the transmitting device 102 may trigger the receiving device 104 to begin measurement of the at least one SS-RS (NLOS sensing signals) and report those measurements back to the transmitting device 102.

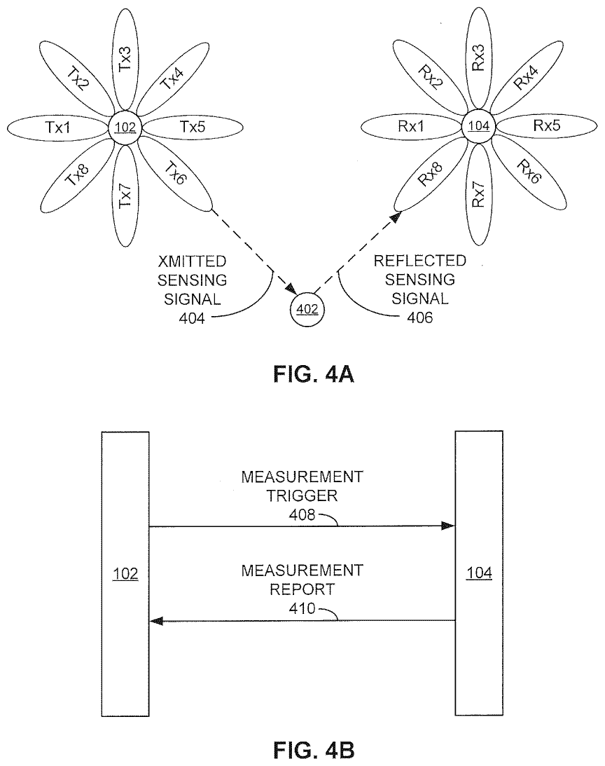

FIG. 4A is a diagram illustrating transmission of an NLOS transmitted sensing signal 404 that is transmitted by the transmitting device 102 and reflected by an object 402 toward the receiving device 104 as a reflected sensing signal 406, according to an example implementation of the present disclosure. As employed herein in some implementations, the object 402 may be a non-NR-communication object. Moreover, the object 402 may be an object that passively reflects the transmitted sensing signal 404 as the reflected sensing signal 406 and/or an object that actively reflects (e.g., receives and retransmits, with or without modification) the transmitted sensing signal 404 as the reflected sensing signal 406.

In the example of FIG. 4A, the Tx beam Tx6 (e.g., a Tx beam that is not the Tx beam Tx5 of the beam pair associated with the LOS SSB signal 302 shown in FIG. 3A) is shown as transmitting the transmitted sensing signal 404. In other examples, other Tx beams (e.g., one or more of Tx1-Tx5, Tx7, and Tx8) may also be employed to transmit the same or different transmitted sensing signal 404 (e.g., in a cyclic manner, as described above in connection with FIG. 2). In some examples, the transmitting device 102 may not use Tx beam Tx5, as the use of that beam for transmitting an LOS signal has already been established, and thus may not be useful for sensing reflecting objects via an NLOS (reflected) signal.

Also, in the example of FIG. 4A, the receiving device 104 is shown employing a greater number of Rx beams (eight) relative to the number of Rx beams (four) shown in FIG. 3A. In other examples, any number of Tx beams and/or Rx beams may be utilized by the transmitting device 102 and the receiving device 104, respectively, for the transmission and reception of NLOS sensing signals, as discussed in conjunction with FIGS. 4A and 4B.

FIG. 4B is a diagram illustrating communications between the transmitting device 102 and the receiving device 104 to trigger the measurement of the sensing signals (via a measurement trigger 408) and the generation and transmission of a measurement report (e.g., measurement report 410) at the receiving device 104, and to transmit the measurement report 410 from the receiving device 104 to the transmitting device 102, according to an example implementation of the present disclosure.

In some implementations, the measurement trigger 408 may be in the form of downlink control information (DCI) (e.g., DCI Format 0_1) employed for uplink resource allocation for a physical uplink shared channel (PUSCH) over which the receiving device 104 may transmit the measurement report 410. In some implementations, the measurement trigger 408 may include information identifying the particular measurement configuration ID that was provided in a measurement resource configuration 308, as discussed above.

In response to receiving the measurement trigger 408, the receiving device 104 may measure the at least one SS-RS received at the receiving device 104 according to the previously received measurement resource configuration 308 and generate at least one corresponding measurement report 410 (e.g., according to the previously received measurement report configuration 310) to report the measurements made.

In some implementations, the receiving device 104 may transmit the measurement report 410 as a MeasResults information element (IE) (e.g., in the form of MeasurementReport(measResults(measResultNeighCells(MeasResultListNR(MeasResultNR(measResult(rsIndexResults(resultsSS-RS-Item(resultsSS-RS-Indexes(ResultsPerSS-RS-Index(1 . . . n)))))))))))). An example of the MeasResults IE is provided below in Table 2.

In some implementations, the measurement report 410 may include, but is not limited to, one or more of the following measurement data items with respect to a particular receive (Rx) beam with which a reflected sensing signal 406 was received and measured:

An identity of the receive beam (e.g., an index of the Rx beam of a beam pair)

An identity of the transmit beam associated with the receive beam (e.g., an index of the TX beam of the beam pair)

An RSRP, RSRQ, SINR, and/or phase of the signal associated with the receive beam

An azimuth angle of arrival (AOA) associated with the receive beam

A zenith AOA associated with the receive beam

An orientation of the receive antenna of the receiving device 104 with respect to North (or some other horizontal reference direction)

An orientation of the receive antenna of the receiving device 104 with respect to the horizon (or some other vertical reference direction)

A current position (e.g., latitude, longitude, and altitude) of the receiving device 104

A timestamp associated with the receive beam

In some implementations, the receiving device 104 may receive multiple reflected sensing signals 406 by way of multiple beam pairs. Consequently, the measurement report 410 may include measurements for those multiple signals, resulting in multiple sets of the result items discussed above (e.g., one per reflected sensing signal 406).

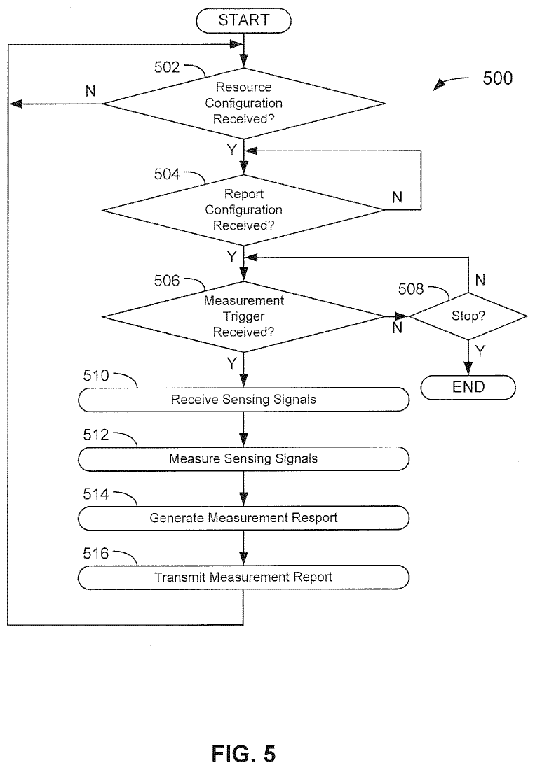

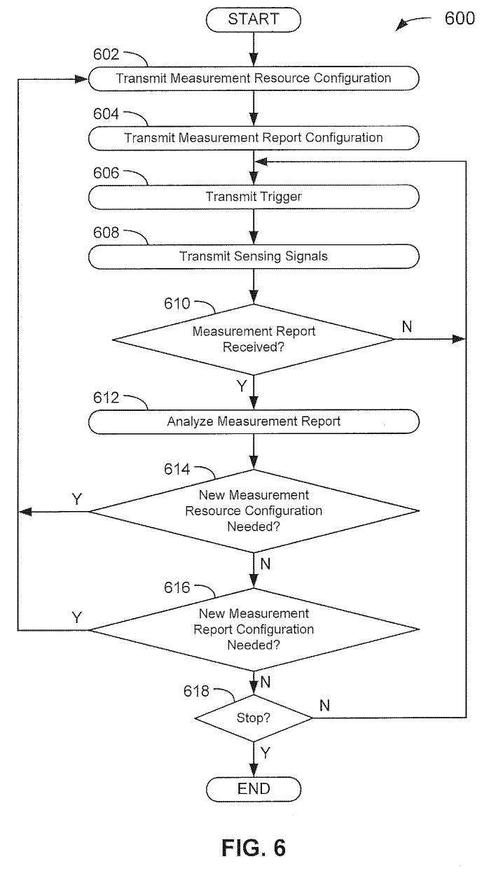

FIG. 5 is a flowchart illustrating a method 500 performed by a receiving device (e.g., receiving device 104) for a sensing operation, according to an example implementation of the present disclosure. Correspondingly, FIG. 6 is a flowchart illustrating a method 600 performed by a transmitting device (e.g., transmitting device 102) for a sensing operation, according to an example implementation of the present disclosure. At the beginning of methods 500 and 600, the receiving device 104 may have already identified (e.g., by way of receiving an SSB) a Tx-Rx beam pair associated with an LOS signal (e.g., LOS SSB signal 302 of FIG. 3A) received from the transmitting device.

In the method 500 of FIG. 5, at operation 502, the receiving device may determine whether it has received a measurement resource configuration (e.g., measurement resource configuration 308 of FIG. 3B). If not, the receiving device may continue to await reception of the measurement resource configuration before continuing. If the receiving device has received the measurement resource configuration, then at operation 504, the receiving device may determine whether it has received a measurement report configuration (e.g., measurement report configuration 310 of FIG. 3B). If not, the receiving device may continue to await reception of the measurement report configuration.

If the receiving device has received the measurement report configuration, then the receiving device may proceed to operation 506 to determine whether a measurement trigger (e.g., measurement trigger 408 of FIG. 4B) is received. If not, the receiving device may proceed to operation 508 to determine whether the sensing operation should be terminated. In some implementations, the receiving device may determine that the sensing operation should be terminated based on an explicit indication from the transmitting device, a timeout of a timer maintained by the receiving device, a loss of connection with the transmitting device, or some other reason. Otherwise, the receiving device may return to operation 506 to await reception of the measurement trigger.

If, instead, the receiving device has received a measurement trigger, the receiving device may then proceed to receiving the sensing signals (e.g., at least one SS-RS) (operation 510), measuring the sensing signals (operation 512), generating one or more measurement reports (operation 514), and transmitting the one or more measurement reports (e.g., as measurement report 410 of FIG. 4B) (operation 516) before awaiting another measurement resource configuration at operation 502.

While operations 502-516 are shown as being performed in a sequential manner, at least some of operations 502-516 may be performed in a different order from that shown, or in a partially overlapping fashion. For example, the receiving device may receive (operation 510) and measure (operation 512) the sensing signals in an overlapped and ongoing manner for at least some period of time after a measurement trigger has been received (operation 506).

In the method 600 of FIG. 6, at operation 602, the transmitting device may transmit a measurement resource configuration (e.g., measurement resource configuration 308 of FIG. 3B) and, at operation 604, transmit a measurement report configuration (e.g., measurement report configuration 310 of FIG. 3B) to a receiving device (e.g., receiving device 104). Thereafter, the transmitting device may transmit, at operation 606, a measurement trigger (e.g., measurement trigger 408 of FIG. 4B) and transmit, at operation 608, sensing signals to be measured (e.g., transmitted sensing signal 404 of FIG. 4A).

Thereafter, at operation 610, the transmitting device may determine whether a measurement report (e.g., measurement report 410 of FIG. 4B) has been received. If not, the transmitting device may transmit a new measurement trigger (e.g., a trigger for a different measurement resource configuration) to the receiving device at operation 606. Otherwise, if the transmitting device has received a measurement report, the transmitting device may proceed to operation 612 to analyze the measurement report (e.g., to determine if sufficient information regarding possible reflecting objects within the vicinity of the transmitting device and the receiving device has been developed).

Thereafter, based on the analysis of the measurement report, the transmitting device may determine whether either a new measurement resource configuration (at operation 614) or a new measurement report configuration (at operation 616) needs to be created and transmitted to the receiving device (e.g., to alter the nature of the sensing signals and/or the measurements of those signals). If a new version of either configuration is desired, the transmitting device my return to operation 602 to begin the process anew. If, instead, neither is desired, the transmitting device may proceed to operation 618 to determine if a new measurement trigger (e.g., related to another measurement resource configuration or measurement report configuration) is desired, the transmitting device may proceed to operation 606 to issue a new measurement trigger to generate another measurement report for analysis. Otherwise, the transmitting device may terminate the sensing operation.

As was the case with method 500 of FIG. 5, while operations 602-618 of FIG. 6 are shown as being performed in a sequential manner, at least some of operations 602-618 may be performed in a different order from that shown, or in a partially overlapping fashion.

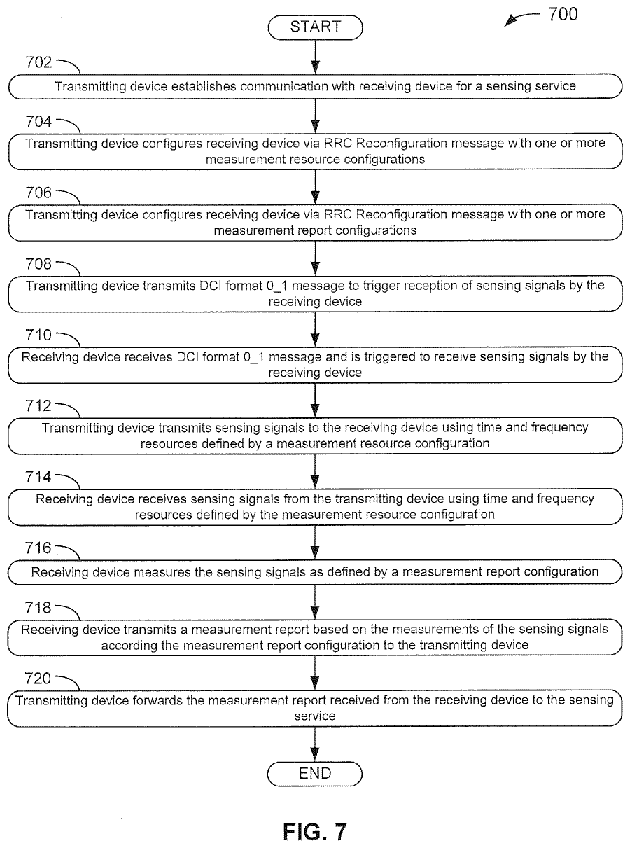

FIG. 7 is a flowchart illustrating a method 700 performed by a transmitting device (e.g., transmitting device 102) and a receiving device (e.g., receiving device 104) for a sensing operation, according to an example implementation of the present disclosure. In the method 700, at operation 702, the transmitting device may establish communication with the receiving device, such as to perform a sensing operation for a sensing service. In some implementations, the communication may be established in part by way of SSBs (e.g., in one or more SSB bursts) to determine a LOS Tx-Rx beam pair, as described above in conjunction with FIGS. 3A and 3B (e.g., using SIB1 304 and PRACH 306 transmissions).

Thereafter, the transmitting device may configure the receiving device (e.g., by way of one or more RRC Reconfiguration messages), with one or more measurement resource configurations (at operation 704) and one or more measurement report configurations (at operation 706) (e.g., measurement resource configuration 308 and measurement report configuration 310, as depicted in FIG. 3B).

The transmitting device, at operation 708, may then transmit a measurement trigger (e.g., via DCI Format 0_1) to the receiving device to trigger the reception and measurement of the sensing signals. Accordingly, the receiving device may receive the measurement trigger at operation 710.

In conjunction with the measurement trigger, the transmitting device, at operation 712, may transmit the sensing signals (e.g., using the time and frequency resource indicated in a previously transmitted measurement resource configuration) to the receiving device. Upon receiving the measurement trigger, the receiving device, at operation 714, may receive the sensing signals according to the information provided in the measurement resource configuration and, at operation 716, may perform the measurements on the sensing signals as defined by the previously received measurement report configuration to generate the desired measurement report.

Thereafter, at operation 718, the receiving device may transmit the generated measurement report to the transmitting device. In some implementations, the transmitting device may determine whether additional sensing activities (e.g., using one or more additional measurement triggers, possibly in connection with one or more measurement resource and/or report configurations) may be needed or desired to gather more information regarding the location of reflecting objects located near the transmitting and receiving devices. In other implementations, the transmitting device may proceed to operation 720, by which the transmitting device forwards the measurement report received from receiving device to a sensing service (e.g., a service running on a computing system or network communicatively coupled to the transmitting device).

In some implementations, as described above, a new data set (e.g., a MeasResults IE) is defined that may capture details regarding measurements taken upon received signals. The received signals may be of a class of signals that may be described as NLOS signals from the transmitting device. Details of the data set may include data regarding the index of a received beam and the index of its associated transmitted beam, the zenith angle of a received beam relative to its receive antenna of the receiving device, the azimuth angle of a received beam relative to its receive antenna of the receiving device, an orientation of the receive antenna relative to North or some other first reference direction, an orientation of the receive antenna relative to the horizon or some other second reference direction orthogonal to the first reference direction, a time at which a received beam was received, and/or the RSRP/RSRQ/SINR/phase of a received beam.

In some implementations, the data set may be part of a new information element (e.g., a MeasResults IE is) defined as part of the 3GPP NR measurement reporting system, the new information element being transmitted by a receiving device to the 3GPP NR system, and the new information element carrying the new data set from a 3GPP NR receiving device to the 3GPP NR System.

Further, in some implementations, the new data set of the new information element may be used to assist a sensing service of a 3GPP NR system to identify objects within the RF environment of a 3GPP NR transmitter, where such objects are not enabled with an active 3GPP NR system transmitter/receiver.

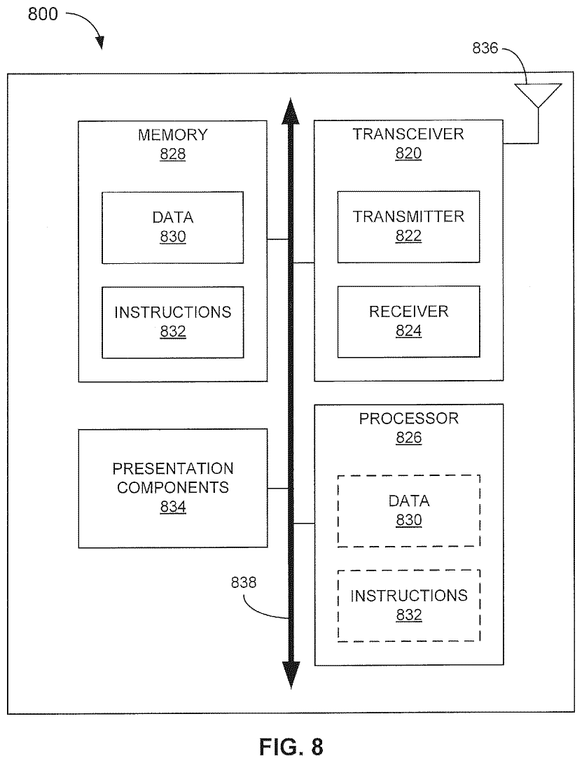

FIG. 8 illustrates a block diagram of a node for wireless communication, according to one example implementation of the present application. As shown in FIG. 8, node 800 may include transceiver 820, processor 826, memory 828, one or more presentation components 834, and at least one antenna 836. Node 800 may also include a Radio Frequency (RF) spectrum band module, a base station communications module, a network communications module, and a system communications management module, input/output (I/O) ports, I/O components, and power supply (not explicitly shown in FIG. 8). Each of these components may be in communication with each other, directly or indirectly, over one or more buses 840.

Transceiver 820 having transmitter 822 and receiver 824 may be configured to transmit and/or receive time and/or frequency resource partitioning information. In some implementations, transceiver 820 may be configured to transmit in different types of subframes and slots including, but not limited to, usable, non-usable, and flexibly usable subframes and slot formats. Transceiver 820 may be configured to receive data and control signaling.

Node 800 may include a variety of computer-readable media. Computer-readable media can be any available media that can be accessed by node 800 and include both volatile and non-volatile media, removable and non-removable media. By way of example, and not limitation, computer-readable media may include computer storage media and communication media. Computer storage media may include both volatile and non-volatile, removable and non-removable media implemented in any method or technology for storage of information, such as computer-readable instructions, data structures, program modules, or other data.

Computer storage media include RAM, ROM, EEPROM, flash memory, or other memory technology, CD-ROM, digital versatile disks (DVD), or other optical disk storage, magnetic cassettes, magnetic tape, magnetic disk storage, or other magnetic storage devices. Computer storage media do not include a propagated data signal. Communication media typically embody computer-readable instructions, data structures, program modules, or other data in a modulated data signal, such as a carrier wave, or other transport mechanism and includes any information delivery media. The term “modulated data signal” means a signal that has one or more of its characteristics set or changed in such a manner as to encode information in the signal. By way of example, and not limitation, communication media include wired media, such as a wired network or direct-wired connection, and wireless media, such as acoustic, RF, infrared, and other wireless media. Combinations of any of the above should also be included within the scope of computer-readable media.

Memory 828 may include computer-storage media in the form of volatile and/or non-volatile memory. Memory 828 may be removable, non-removable, or a combination thereof. Exemplary memory includes solid-state memory, hard drives, optical-disc drives, etc. As illustrated in FIG. 8, memory 828 may store computer-readable, computer-executable instructions 832 (e.g., software codes) that are configured to, when executed, cause processor 826 to perform various functions described herein, for example, with reference to FIGS. 1 through 7. Alternatively, instructions 832 may not be directly executable by processor 826 but be configured to cause node 800 (e.g., when compiled and executed) to perform various functions described herein.

Processor 826 may include an intelligent hardware device, for example, a central processing unit (CPU), a microcontroller, an ASIC, etc. Processor 826 may include memory. Processor 826 may process data 830 and instructions 832 received from memory 828, and information through transceiver 820, the baseband communications module, and/or the network communications module. Processor 826 may also process information to be sent to transceiver 820 for transmission through antenna 836, to the network communications module for transmission to a core network.

One or more presentation components 834 presents data indications to a person or other device. For example, one or more presentation components 834 include a display device, speaker, printing component, vibrating component, etc.

From the above description, it is manifest that various techniques can be used for implementing the concepts described in the present application without departing from the scope of those concepts. Moreover, while the concepts have been described with specific reference to certain implementations, a person of ordinary skill in the art may recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

An example of a MeasResults IE is illustrated in Table 2 below. In some implementations, the IE MeasResults provides measurement results for reflected NLOS signals received by a receiving device, such as a UE.

TABLE 2
MeasResults IE

-- ASN1START
-- TAG-MEASRESULTS-START

| | |
|---|---|
| MeasResults ::= | SEQUENCE { |
| measId | MeasId, |
| measResultServingMOList | MeasResultServMOList, |
| measResultNeighCells | CHOICE { |
| measResultListNR | MeasResultListNR, |

...,

| measResultListEUTRA | MeasResultListEUTRA, | |
|---|---|---|
| measResultListUTRA-FDD-r16 | MeasResultListUTRA-FDD-r16, | |
| sl-MeasResultsCandRelay-r17 | OCTET STRING | -- Contains PC5 |

```
SL-MeasResultListRelay-r17
  }
OPTIONAL,
  ...,
  [[
```

| | |
|---|---|
| measResultServFreqListEUTRA-SCG | MeasResultServFreqListEUTRA-SCG |

OPTIONAL,

| | |
|---|---|
| measResultServFreqListNR-SCG | MeasResultServFreqListNR-SCG |

OPTIONAL,

| | |
|---|---|
| measResultSFTD-EUTRA | MeasResultSFTD-EUTRA |

OPTIONAL,

| | |
|---|---|
| measResultSFTD-NR | MeasResultCellSFTD-NR |

```
OPTIONAL
    ]],
    [[
```

| | |
|---|---|
| measResultCellListSFTD-NR | MeasResultCellListSFTD-NR |

```
OPTIONAL
  ]],
  [[
```

| | |
|---|---|
| measResultForRSSI-r16 | MeasResultForRSSI-r16 |

OPTIONAL,

| | |
|---|---|
| locationInfo-r16 | LocationInfo-r16 |

OPTIONAL,

| | |
|---|---|
| ul-PDCP-DelayValueResultList-r16 | UL-PDCP-DelayValueResultList-r16 |

OPTIONAL,

| | |
|---|---|
| measResultsSL-r16 | MeasResultsSL-r16 |

OPTIONAL,

| | |
|---|---|
| measResultCLI-r16 | MeasResultCLI-r16 |

```
OPTIONAL
  ]],
  [[
```

| | |
|---|---|
| measResultRxTxTimeDiff-r17 | MeasResultRxTxTimeDiff-r17 |

OPTIONAL,

| | |
|---|---|
| sl-MeasResultServingRelay-r17 | OCTET STRING |

OPTIONAL,

-- Contains

PC5 SL-MeasResultRelay-r17

| | |
|---|---|
| ul-PDCP-ExcessDelayResultList-r17 | UL-PDCP-ExcessDelayResultList-r17 |

OPTIONAL,

| | |
|---|---|
| coarseLocationInfo-r17 | OCTET STRING |

OPTIONAL
]]
}
----Content of this IE unrelated to this disclosure is not shown for brevity ---

| | |
|---|---|
| MeasResultNR ::= | SEQUENCE { |
| physCellId | PhysCellId |

OPTIONAL,

| | |
|---|---|
| measResult | SEQUENCE { |
| cellResults | SEQUENCE { |
| resultsSSB-Cell | MeasQuantityResults |

OPTIONAL,

| | |
|---|---|
| resultsCSI-RS-Cell | MeasQuantityResults |

OPTIONAL
},

| | |
|---|---|
| rsIndexResults | SEQUENCE { |
| resultsSSB-Indexes | ResultsPerSSB-IndexList |

OPTIONAL,

| | |
|---|---|
| resultsCSI-RS-Indexes | ResultsPerCSI-RS-IndexList |

OPTIONAL,

| | |
|---|---|
| resultsSS-RS-Item | ResultsSS-RS-Item |

```
OPTIONAL
  }
OPTIONAL
  },
  ...,
  [[
```

| | |
|---|---|
| cgi-Info | CGI-InfoNR |

```
OPTIONAL
  ]] ,
  [[
```

| | |
|---|---|
| choCandidate-r17 | ENUMERATED {true} |

OPTIONAL,

| | |
|---|---|
| choConfig-r17 | SEQUENCE (SIZE (1..2)) OF |
| CondTriggerConfig-r16 | OPTIONAL, |
| triggeredEvent-r17 | SEQUENCE { |
| timeBetweenEvents-r17 | TimeBetweenEvent-r17 |

OPTIONAL,

| | |
|---|---|
| firstTriggeredEvent | ENUMERATED {condFirstEvent, |
| condSecondEvent} | OPTIONAL |

```
    }
OPTIONAL
  ]]
}
----Content of this IE unrelated to this disclosure is not shown for brevity ---
```

| | |
|---|---|
| ResultsPerSS-RS-Item ::= | SEQUENCE { |
| resultsSS-RS-Indexes | ResultsPerSS-RS-IndexList, |

OPTIONAL

| | | |
|---|---|---|
| coarseLocationInfo-r17 | OCTET STRING, | --already available |

above in MeasResults

| | | |
|---|---|---|
| orientationUE_To_North | INTEGER(0..359) | --Orientation of UE |

relative to North

| | | |
|---|---|---|
| orientationUE_To_Horizion | INTEGER(0..359) | --Orientation of UE |

relative to Horizon
}

| | |
|---|---|
| ResultsPerSS-RS-IndexList::= | SEQUENCE (SIZE (1..maxNrofIndexesToReport2)) OF |

ResultsPerSS-RS-Index

| ResultsPerSS-RS-Index ::= | SEQUENCE { | |
|---|---|---|
| ss-RS-Index_Tx | SS-RS-Index, | -- Index associated |

with the Tx beam

| | | |
|---|---|---|
| ss-RS-Index_Rx | SS-RS-Index, | -- Index associated |

with the Rx beam

| | | |
|---|---|---|
| ss-RS-Result_Rx | MeasQuantityResults_ss-RS | -- Signal |

strength and phase of received signal.

| | | |
|---|---|---|
| ss-RS-Result_Rx_BeamAzimuth | INTEGER(0..179) | -- Deg of beam in |

the X-plane of Rx antenna

| | | |
|---|---|---|
| ss-RS-Result_Rx_BeamZenith | INTEGER(0..179) | -- Deg of beam in |

the Y-plane of Rx antenna

| | | |
|---|---|---|
| time-r16 | ReferenceTime-r16 | -- time of beam |

detection
}

| SS-RS-Index ::= | INTEGER (0..maxNrofSS-RS-ResourcesRRM-1) | |
|---|---|---|
| maxNrofSS-RS-ResourcesRRM-1 | INTEGER ::= 95 | -- Max SS-RS resources/cell |

for RRM meas object minus 1.

| | |
|---|---|
| MeasQuantityResults_ss-RS ::= | SEQUENCE { |
| rsrp | RSRP-Range |

OPTIONAL,

| | |
|---|---|
| rsrq | RSRQ-Range |

OPTIONAL,

| | |
|---|---|
| sinr | SINR-Range |

OPTIONAL,

| | | |
|---|---|---|
| phase | PHASE | -- Phase |

of received beam OPTIONAL
}

| | |
|---|---|
| PHASE ::= | INTEGER(0..359) |

----Content of this IE unrelated to this disclosure is not shown for brevity ---
TimeBetweenEvent-r17 ::= INTEGER (0..1023)
-- TAG-MEASRESULTS-STOP
-- ASN1STOP

In one example, a transmitting device of a New Radio (NR) system configured to detect objects, the transmitting device comprising: one or more non-transitory computer-readable media storing a set of computer-executable instructions; and at least one processor coupled to the one or more non-transitory computer-readable media and configured to execute the set of computer-executable instructions to cause the transmitting device to perform operations comprising: transmitting, to a receiving device via a line-of-sight (LOS) path between the transmitting device and the receiving device, a measurement resource configuration indicating time and frequency resources for a sensing signal; transmitting, to the receiving device via another path different from the LOS path, the sensing signal via the time and frequency resources; and receiving, from the receiving device via the LOS path, a measurement report comprising measurement data, the measurement data comprising an indication of a direction from which a reflection of the sensing signal was received at the receiving device.

In one example, the transmitting device, wherein: the measurement report comprises a MeasResults information element (IE).

In one example, the transmitting device, wherein: the indication of the direction from which the reflection of the sensing signal was received at the receiving device comprises an identity of a receive beam of the receiving device used to receive the reflection of the sensing signal.

In one example, the transmitting device, wherein: the indication of the direction from which the reflection of the sensing signal was received at the receiving device comprises at least one of a first orientation of a receive antenna of the receiving device with respect to a first reference direction, or a second orientation of the receive antenna of the receiving device with respect to a second reference direction orthogonal to the first reference direction.

In one example, the transmitting device, wherein: the indication of the direction from which the reflection of the sensing signal was received at the receiving device comprises at least one of an azimuth angle of arrival (AOA) associated with the reflection of the sensing signal at the receiving device, or a zenith AOA associated with the reflection of the sensing signal at the receiving device.

In one example, the transmitting device, wherein: the measurement data further comprises an identity of a transmit beam of the transmitting device used to transmit the sensing signal.

In one example, the transmitting device, wherein: the measurement data further comprises a current position of the receiving device.

In one example, the transmitting device, wherein the measurement data further comprises at least one of: a reference signal received power (RSRP) of the reflection of the sensing signal at the receiving device; a reference signal received quality (RSRQ) of the reflection of the sensing signal at the receiving device; a signal-to-interference-and-noise ratio (SINR) of the reflection of the sensing signal at the receiving device; or a phase of the reflection of the sensing signal at the receiving device.

In one example, the transmitting device, wherein: the measurement data further comprises a timestamp related to receiving the reflection of the sensing signal at the receiving device.

In one example, the transmitting device, the operations further comprising: transmitting, to the receiving device via the LOS path, after transmitting the measurement resource configuration, a measurement trigger to cause the receiving device to begin receiving and measuring the sensing signal.

In one example, a method performed by a transmitting device of a New Radio (NR) system configured to detect objects, the method comprising: transmitting, to a receiving device via a line-of-sight (LOS) path between the transmitting device and the receiving device, a measurement resource configuration indicating time and frequency resources for a sensing signal; ransmitting, to the receiving device via another path different from the LOS path, the sensing signal via the time and frequency resources; and receiving, from the receiving device via the LOS path, a measurement report comprising measurement data, the measurement data comprising an indication of a direction from which a reflection of the sensing signal was received at the receiving device.

In one example, the method, wherein: the measurement report comprises a MeasResults information element (IE).

In one example, the method, wherein: the indication of the direction from which the reflection of the sensing signal was received at the receiving device comprises an identity of a receive beam of the receiving device used to receive the reflection of the sensing signal.

In one example, the method, wherein: the indication of the direction from which the reflection of the sensing signal was received at the receiving device comprises at least one of a first orientation of a receive antenna of the receiving device with respect to a first reference direction, or a second orientation of the receive antenna of the receiving device with respect to a second reference direction orthogonal to the first reference direction.

In one example, the method, wherein: the indication of the direction from which the reflection of the sensing signal was received at the receiving device comprises at least one of an azimuth angle of arrival (AOA) associated with the reflection of the sensing signal at the receiving device, or a zenith AOA associated with the reflection of the sensing signal at the receiving device.

In one example, the method, wherein: the measurement data further comprises an identity of a transmit beam of the transmitting device used to transmit the sensing signal.

In one example, the method, wherein: the measurement data further comprises a current position of the receiving device.

In one example, the method, wherein the measurement data further comprises at least one of: a reference signal received power (RSRP) of the reflection of the sensing signal at the receiving device; a reference signal received quality (RSRQ) of the reflection of the sensing signal at the receiving device; a signal-to-interference-and-noise ratio (SINR) of the reflection of the sensing signal at the receiving device; or a phase of the reflection of the sensing signal at the receiving device.

In one example, the method, wherein: the measurement data further comprises a timestamp related to receiving the reflection of the sensing signal at the receiving device.

In one example, the method, further comprising: transmitting, to the receiving device via the LOS path, after transmitting the measurement resource configuration, a measurement trigger to cause the receiving device to begin receiving and measuring the sensing signal.

In one example, a receiving device of a New Radio (NR) system configured to detect objects, the receiving device comprising: one or more non-transitory computer-readable media storing a set of computer-executable instructions; and at least one processor coupled to the one or more non-transitory computer-readable media and configured to execute the set of computer-executable instructions to cause the receiving device to perform operations comprising: receiving, from a transmitting device via a line-of-sight (LOS) path between the transmitting device and the receiving device, a measurement resource configuration indicating time and frequency resources for a sensing signal; receiving, from the transmitting device via another path different from the LOS path, a reflection of the sensing signal via the time and frequency resources; and transmitting, to the transmitting device via the LOS path, a measurement report comprising measurement data, the measurement data comprising an indication of a direction from which the reflection of the sensing signal was received at the receiving device.

In one example, the receiving device, wherein: the measurement report comprises a MeasResults information element (IE).

In one example, the receiving device, wherein: the indication of the direction from which the reflection of the sensing signal was received at the receiving device comprises an identity of a receive beam of the receiving device used to receive the reflection of the sensing signal.

In one example, the receiving device, wherein: the indication of the direction from which the reflection of the sensing signal was received at the receiving device comprises at least one of a first orientation of a receive antenna of the receiving device with respect to a first reference direction, or a second orientation of the receive antenna of the receiving device with respect to a second reference direction orthogonal to the first reference direction.

In one example, the receiving device, wherein: the indication of the direction from which the reflection of the sensing signal was received at the receiving device comprises at least one of an azimuth angle of arrival (AOA) associated with the reflection of the sensing signal at the receiving device, or a zenith AOA associated with the reflection of the sensing signal at the receiving device.

In one example, the receiving device, wherein: the measurement data further comprises an identity of a transmit beam of the transmitting device used to transmit the sensing signal.

In one example, the receiving device, wherein: the measurement data further comprises a current position of the receiving device.

In one example, the receiving device, wherein the measurement data further comprises at least one of: a reference signal received power (RSRP) of the reflection of the sensing signal at the receiving device; a reference signal received quality (RSRQ) of the reflection of the sensing signal at the receiving device; a signal-to-interference-and-noise ratio (SINR) of the reflection of the sensing signal at the receiving device; or a phase of the reflection of the sensing signal at the receiving device.

In one example, the receiving device, wherein: the measurement data further comprises a timestamp related to receiving the reflection of the sensing signal at the receiving device.

In one example, the receiving device, the operations further comprising: receiving, from the transmitting device via the LOS path between the transmitting device and the receiving device, after receiving the measurement resource configuration, a measurement trigger that causes the receiving device to begin receiving and measuring the sensing signal.

In one example, a method performed by a receiving device of a New Radio (NR) system configured to detect objects, the method comprising: receiving, from a transmitting device via a line-of-sight (LOS) path between the transmitting device and the receiving device, a measurement resource configuration indicating time and frequency resources for a sensing signal; receiving, from the transmitting device via another path different from the LOS path, a reflection of the sensing signal via the time and frequency resources; and transmitting, to the transmitting device via the LOS path, a measurement report comprising measurement data, the measurement data comprising an indication of a direction from which the reflection of the sensing signal was received at the receiving device.

In one example, the method, wherein: the measurement report comprises a MeasResults information element (IE).

In one example, the method, wherein: the indication of the direction from which the reflection of the sensing signal was received at the receiving device comprises an identity of a receive beam of the receiving device used to receive the reflection of the sensing signal.

In one example, the method, wherein: the indication of the direction from which the reflection of the sensing signal was received at the receiving device comprises at least one of a first orientation of a receive antenna of the receiving device with respect to a first reference direction, or a second orientation of the receive antenna of the receiving device with respect to a second reference direction orthogonal to the first reference direction.

In one example, the method, wherein: the indication of the direction from which the reflection of the sensing signal was received at the receiving device comprises at least one of an azimuth angle of arrival (AOA) associated with the reflection of the sensing signal at the receiving device, or a zenith AOA associated with the reflection of the sensing signal at the receiving device.

In one example, the method, wherein: the measurement data further comprises an identity of a transmit beam of the transmitting device used to transmit the sensing signal.

In one example, the method, wherein: the measurement data further comprises a current position of the receiving device.

In one example, the method, wherein the measurement data further comprises at least one of: a reference signal received power (RSRP) of the reflection of the sensing signal at the receiving device; a reference signal received quality (RSRQ) of the reflection of the sensing signal at the receiving device; a signal-to-interference-and-noise ratio (SINR) of the reflection of the sensing signal at the receiving device; or a phase of the reflection of the sensing signal at the receiving device.

In one example, the method, wherein: the measurement data further comprises a timestamp related to receiving the reflection of the sensing signal at the receiving device.

In one example, the method, further comprising: receiving, from the transmitting device via the LOS path between the transmitting device and the receiving device, after receiving the measurement resource configuration, a measurement trigger that causes the receiving device to begin receiving and measuring the sensing signal.

### CROSS REFERENCE

This Nonprovisional application claims priority under 35 U.S.C. § 119 on provisional Application No. 63/478,634 on Jan. 5, 2023, the entire contents of which are hereby incorporated by reference.

1. A transmitting device of a New Radio (NR) system configured to detect objects, the transmitting device comprising:
one or more non-transitory computer-readable media storing a set of computer-executable instructions; and
at least one processor coupled to the one or more non-transitory computer-readable media and configured to execute the set of computer-executable instructions to cause the transmitting device to perform operations comprising:
transmitting, to a receiving device via a line-of-sight (LOS) path between the transmitting device and the receiving device, a measurement resource configuration indicating time and frequency resources for a sensing signal;
transmitting, to the receiving device via another path different from the LOS path, the sensing signal via the time and frequency resources; and
receiving, from the receiving device via the LOS path, a measurement report comprising measurement data, the measurement data comprising an indication of a direction from which a reflection of the sensing signal was received at the receiving device.

2. The transmitting device of claim 1, wherein:
the measurement report comprises a MeasResults information element (IE).

3. The transmitting device of claim 1, wherein:
the indication of the direction from which the reflection of the sensing signal was received at the receiving device comprises an identity of a receive beam of the receiving device used to receive the reflection of the sensing signal.

4. The transmitting device of claim 1, wherein:
the measurement data further comprises a timestamp related to receiving the reflection of the sensing signal at the receiving device.

5. The transmitting device of claim 1, the operations further comprising:
transmitting, to the receiving device via the LOS path, after transmitting the measurement resource configuration, a measurement trigger to cause the receiving device to begin receiving and measuring the sensing signal.

6. A receiving device of a New Radio (NR) system configured to detect objects, the receiving device comprising:
one or more non-transitory computer-readable media storing a set of computer-executable instructions; and
at least one processor coupled to the one or more non-transitory computer-readable media and configured to execute the set of computer-executable instructions to cause the receiving device to perform operations comprising:
receiving, from a transmitting device via a line-of-sight (LOS) path between the transmitting device and the receiving device, a measurement resource configuration indicating time and frequency resources for a sensing signal;
receiving, from the transmitting device via another path different from the LOS path, a reflection of the sensing signal via the time and frequency resources; and
transmitting, to the transmitting device via the LOS path, a measurement report comprising measurement data, the measurement data comprising an indication of a direction from which the reflection of the sensing signal was received at the receiving device.

7. The receiving device of claim 6, wherein:
the measurement report comprises a MeasResults information element (IE).

8. The receiving device of claim 6, wherein:
the indication of the direction from which the reflection of the sensing signal was received at the receiving device comprises an identity of a receive beam of the receiving device used to receive the reflection of the sensing signal.

9. The receiving device of claim 6, wherein:
the indication of the direction from which the reflection of the sensing signal was received at the receiving device comprises at least one of a first orientation of a receive antenna of the receiving device with respect to a first reference direction, or a second orientation of the receive antenna of the receiving device with respect to a second reference direction orthogonal to the first reference direction.

10. The receiving device of claim 6, wherein:
the indication of the direction from which the reflection of the sensing signal was received at the receiving device comprises at least one of an azimuth angle of arrival (AOA) associated with the reflection of the sensing signal at the receiving device, or a zenith AOA associated with the reflection of the sensing signal at the receiving device.

11. The receiving device of claim 6, wherein:
the measurement data further comprises an identity of a transmit beam of the transmitting device used to transmit the sensing signal.

12. The receiving device of claim 6, wherein:
the measurement data further comprises a current position of the receiving device.

13. The receiving device of claim 6, wherein the measurement data further comprises at least one of:
a reference signal received power (RSRP) of the reflection of the sensing signal at the receiving device;
a reference signal received quality (RSRQ) of the reflection of the sensing signal at the receiving device;
a signal-to-interference-and-noise ratio (SINR) of the reflection of the sensing signal at the receiving device; or
a phase of the reflection of the sensing signal at the receiving device.

14. The receiving device of claim 6, wherein:
the measurement data further comprises a timestamp related to receiving the reflection of the sensing signal at the receiving device.

15. The receiving device of claim 6, the operations further comprising: receiving, from the transmitting device via the LOS path between the transmitting device and the receiving device, after receiving the measurement resource configuration, a measurement trigger that causes the receiving device to begin receiving and measuring the sensing signal.
